(19) United States
(12) Patent Application Publication
(10) Pub. No.: US 2009/0101761 A1
(43) Pub. Date: Apr. 23, 2009

(54) Hand-held electrical power tool with flexural protection member

(75) Inventors: Stefan Hammerstingl, Munich (DE); Holger Cecchin, Puchhein (DE); Michael Lanzinger, Munich (DE)

Correspondence Address: ABELMAN, FRAYNE & SCHWAB, 666 THIRD AVENUE, 10TH FLOOR, NEW YORK, NY, 10017, US

(73) Assignee: Hilti Aktiengesellschaft

(21) Appl. No.: 12/288,002

(22) Filed: Oct. 14, 2008

(30) Foreign Application Priority Data
Oct. 17, 2007 (DE) 10 2007 000 513.1

(51) Int. Cl. F16L 3/01

(52) U.S. Cl. 248/52

(57) ABSTRACT

A hand-held electrical power tool has at least two shell sections (5a, 5b) arranged in the tool housing (3) and forming a feed opening (6) therebetween through which a power supply cable (7) is inserted, and an elastic flexural protection member (8) which surrounds the power supply cable (7) radially outwardly for securing same in the housing (3) and which is formlockingly secured, over a radial collar (9) provided in a housing interior, in recesses (10) between the two shell sections (5a, 5b), with clamping ribs (12) being provided in at least one (5a) shell section (5a) on an inner side of a respective recess (10) for at least forcelockingly securing the power supply cable (7) on the at least one shell section (5a).

### BACKGROUND OF THE INVENTION

1. Field of the Invention

The present invention relates to a hand-held electrical power tool, in particular, a combination hammer, having a flexural protection member for the power supply cable.

2. Description of the Prior Art

Usually, hand-held electrical power tools have a flexural protection member for the housing feed opening for the power supply cable. The flexural protection member elastically stiffens the power supply cable and, thus, protects it with very small radii of curvature.

German Publication DE 11 059 77 discloses a hand-held electrical power tool in which an elastic flexural protection member is provided for the housing feed opening for the power supply cable. The protection member is formlockingly secured, over a radial collar provided in the housing interior, between two shell sections. To provide for tension relief, the power supply cable itself is forcelockingly clamped on a housing shell with a separate screw-type clip. German Utility Model DE 295 02 859 U discloses a cable attachment system that combines flexural protection and tension relief. According to DE 295 02 859 U, two, two-shell, stiff, feed opening shells, which have a smoothly rounded, bell-shaped opening, are positioned around a power supply cable and are introduced from outside into a corresponding circular opening in the housing, whereby they are formlockingly connected and forcelockingly clamp the power supply cable with their, extending radially inwardly, clamping ribs. The so formed stiff, feed opening protection member is not an elastic flexural protection member that is necessary for high-stressed hand-held electrical power tools.

An object of the present invention is a hand-held electrical power tool with a technologically simply realized, flexural protection member and the stress relief.

### SUMMARY OF THE INVENTION

This and other objects of the present invention, which will become apparent hereinafter, are achieved by providing a hand-held electrical power tool having a housing, and at least two shell sections arranged in the housing and forming a feed opening therebetween through which a power supply cable is inserted. An elastic flexural protection member surrounds the power supply cable radially outwardly, securing same in the housing. The flexural protection member is formlockingly secured, over a radial collar provided in a housing interior, in recesses between the two shell sections. Clamping ribs means are provided in at least one of the at least two shell sections, on an inner side of a respective recess for at least forcelockingly securing the power supply cable on the at least one of the at least two shell sections.

With the clamping ribs which are provided on the inner side of the recesses for forcelockingly securing the power supply cable, upon mounting of both shell sections, in a single operational step, the flexural protection member and the power supply cable itself are both, respectively, formlocking and forcelockingly secured. The permits to eliminate an otherwise necessary assembly step to provide separately for stress relief.

Advantageously, cooperating clamping ribs are provided in both shell sections, which insures a forcelocking symmetrical fixation of the power supply cable.

Advantageously, additional clamping means is provided on outer sides of the recesses. Thereby, the flexural protection member is additional forcelockingly secured against rotation.

Advantageously, the clamping ribs are formed with a moon sickle shape, whereby upon assembly of both shall sections, a substantially unidimensional force lock is applied to the power supply cable, reliably deforming the cable cross-section without, however, inwardly located conducting wires being squashed over each other.

Advantageously, the at least two shell sections are arranged opposite each other and are releasably connected with each other, advantageously, forcelockingly, with screw-like elements. Thereby, the power supply cable can be replaced during servicing.

Advantageously, the housing is formed of at least two shells with the at least two shell sections being formlockingly secured therein. Thereby, the shell sections can be pre-assembled with the power supply cable and mounted in the housing during the final assembly.

The novel features of the present invention, which are considered as characteristic for the invention, are set forth in the appended claims. The invention itself, however, both as to its construction and its mode of operation, together with additional advantages and objects thereof, will be best understood from the following detailed description of preferred embodiment, when read with reference to the accompanying drawings.

### BRIEF DESCRIPTION OF THE DRAWINGS

The drawings show:

FIG. 1 a plan view of a hand-held electrical power tool according to the present invention;

FIG. 2 a longitudinal cross-sectional view of a section of the electrical power tool shown in FIG. 1;

FIG. 3 a longitudinal cross-sectional view of a detail of the section shown in FIG. 2 at an increased, in comparison with FIG. 2, scale; and

FIG. 4 a plan view of a shell section.

### DETAILED DESCRIPTION OF THE PREFERRED EMBODIMENT

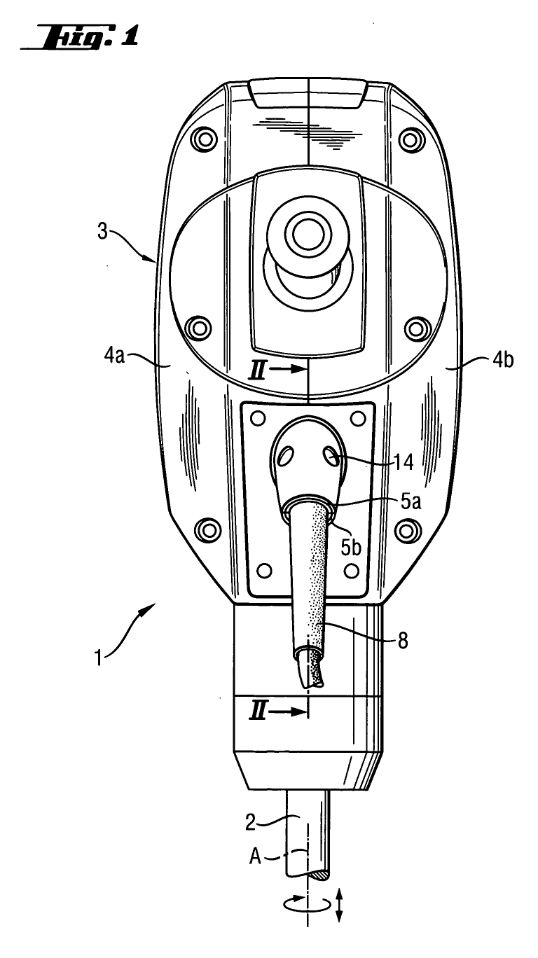

An electrical hand-held rotary percussion power tool 1, which is formed as a combination hammer for rotatably driving a working tool 2 about an axis A and percussively displacing the working tool 2 along the axis A and which is shown in FIG. 1, includes a housing 3 formed of two housing shells 4a, 4b and in which two shell sections 5a, 5b, which are releasably connectable with each other by screw elements 14, are arranged.

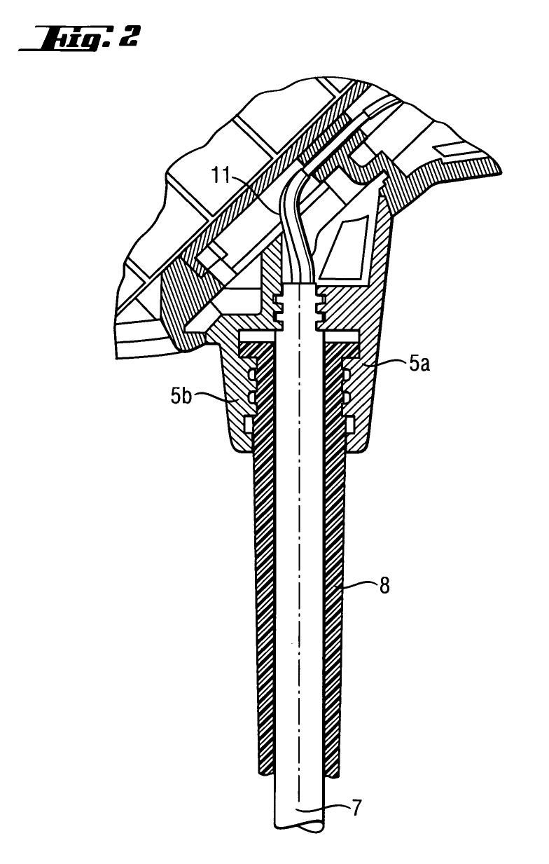

As shown in FIG. 2, the two shell sections 5a, 5b are formlockingly secured in the two housing shells 4a, 4b with an adapter 13 (see FIG. 4). Between the two shell sections 4a, 4b, there is provided a feed opening 6 (FIG. 4) through which a power supply cable 7 is inserted. The cable 7 is surrounded, outside of the housing 3 (see FIG. 1), at least partially with an elastic flexural protection member 8. Inside the housing 3 (see FIG. 2), two stripped network conductors 11 extend from the cable 7.

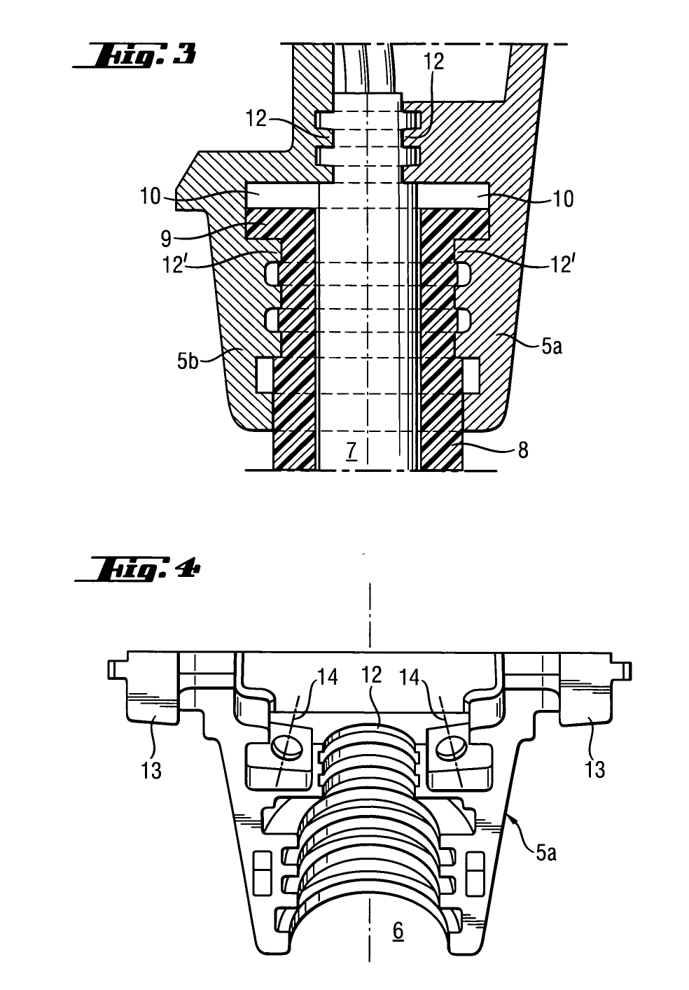

According to FIG. 3, the flexural protection member 8 is formlockingly secured in recesses 10 over a radial collar 9 between the two shell sections 5a, 5b. In both shell sections 5a, 5b, on the inner side of the recesses 10, there are provided associated with each other, clamping ribs 12 for forcelockingly securing the power supply cable 7 on the shell sections 5a, 5b, respectively. On the outer sides of the recesses 10, there are provided additional clamping ribs 12′.

As shown in FIG. 4, in the separately shown shell section 5a, the clamping ribs 12 are moon sickle-shaped.

Though the present invention was shown and described with references to the preferred embodiment, such is merely illustrative of the present invention and is not to be construed as a limitation thereof and various modifications of the present invention will be apparent to those skilled in the art. It is therefore not intended that the present invention be limited to the disclosed embodiment or details thereof, and the present invention includes all variations and/or alternative embodiments within the spirit and scope of the present invention as defined by the appended claims.

What is claimed is:

1. A hand-held electrical power tool, comprising a housing (3); at least two shell sections (5a, 5b) arranged in the housing (3) and forming a feed opening (6) therebetween through which a power supply cable (7) is inserted; an elastic flexural protection member (8) that surrounds the power supply cable (7) radially outwardly for securing same in the housing (3), the flexural protection member (8) being formlockingly secured, over a radial collar (9) provided in a housing interior, in recesses (10) between the two shell sections (5a, 5b); and clamping rib means (12) provided in at least one (5a) of the at least two shell sections (5a, 5b) on an inner side of a respective recess (10) for at least forcelockingly securing the power supply cable (7) on the at least one of the at least two shell sections (5a, 5b).

2. A hand-held electrical power tool according to claim 1, wherein clamping rib means (12) is also provided in another (5b) of the at least two shells sections (5a, 5b), the clamping rib means (12) of another (5b) of the at least two sections (5a, 5b) cooperating with the clamping rib means (12) of the at least one of the at least two sections (5a, 5b).

3. A hand-held electrical power tool according to claim 1, wherein the recesses (10) are provided, on an outer side thereof, with additional clamping ribs (12′).

4. A hand-held electrical power tool according to claim 1, wherein the clamping ribs (12) are formed as moon sickle-shaped ribs.

5. A hand-held electrical power tool according to claim 3, wherein the additional clamping ribs (12′) are formed as moon sickle-shaped ribs.

6. A hand-held electrical power tool according to claim 1, wherein the at least two shell sections (51, 5b) are arranged opposite each other and are releasably connected with each other.

7. A hand-held electrical power tool, according to claim 1, wherein the housing (3) is formed of at least two shell (4a, 4b) and wherein the at least two shell sections (5a, 5b) are formlockingly secured therein.
